(19) United States
(12) Patent Application Publication
(10) Pub. No.: US 2010/0313961 A1
(43) Pub. Date: Dec. 16, 2010

(54) LIQUID MEDIUM SUPPLY METHOD

(75) Inventors: Andrei Vjacheslavovich Nevedeev, Moscow (RU); Anton Viktorovich Danilov-Daniljan, Moscow (RU)

Correspondence Address: HAYNES AND BOONE, LLP;IP Section, 2323 Victory Avenue, Suite 700, Dallas, TX, 75219, US

(73) Assignee: Rint Corporation, Moscow (RU)

(21) Appl. No.: 12/816,272

(22) Filed: Jun. 15, 2010

(30) Foreign Application Priority Data
Jun. 16, 2009 (RU) 2009122678

(51) Int. Cl. F17D 1/16

(52) U.S. Cl. 137/2

(57) ABSTRACT

The invention relates to technology and equipment for liquid media treatment and supply and can be used in oil processing, chemical, medical and other industry branches. The proposed liquid medium supply method is described with use of a dynamic nozzle having elements 12 and 13 forming vortex field and cavity correspondingly as a flow transformation system 8 and the pump 14 use as a depressing device. The liquid medium 1 us supplied to the nozzle inlet and while passing through the nozzle the flow is swirled at the element 12 obtaining a spring form with the set value of rotation and forward speeds relationship, and the element 13 provides continuous nucleation of bubbles, which line up downstream the medium flow being treated with formation of the cavity 9, which later passes into the cavitation 7 controlled zone. In the course of treatment the liquid medium while passing through the cavitation 7 zone is exposed to wave slamming, generated with cavitation bubbles collapse. Besides partial “micro-cracking” takes place—bond opening with radical and decreased molecular weight hydrocarbon generation. Flow rotation provides the entire flow cavitation treatment efficiency.

The invention relates to technology and equipment for liquid media treatment and supply and can be used in oil processing, chemical, medical and other industry fields.

Supplying liquid media to a consumer is generally accomplished through a piping system and is accompanied by considerable power consumption as a result of the liquid media viscosity and compositional inhomogenuety. And in case of high viscosity liquid media with large amount of foreign substances and heterogeneous structure deposits are gradually accumulated on the pipe walls resulting in piping hydraulic resistance increase and even complete obstruction of the flow.

There is a known method for supplying of a liquid medium from a source to a consumer by means of determining physical-chemical parameters of the liquid medium in the source, arranging a transport channel and providing needed pressure differential along the said channel (1).

According to the said method the pressure differential along the operating channel is maintained by a pump, and in the gap between the pump and the transport channel walls high-velocity ejector jets are generated for the pump electric motor cooling.

The disadvantages of said method include high energy consumption, generation of ever-increasing deposits from the liquid medium on the channel walls, increase of the channel hydraulic resistance, decrease of the pumped though liquid medium flow and general decrease of the technological effectiveness of the process.

The closest technical solution is the method of supplying high-viscosity oil in the course of oil field operation to a consumer by means of determining physical-chemical parameters of the oil, arranging a transport channel and providing needed pressure differential along the said channel (2).

According to said technical solution, simultaneously with the high-viscosity oil flowing through the transport channel, a low-viscosity process liquid film flow is arranged along the channel walls, which prevents direct contact of the oil with the walls, thus decreasing flow friction of the oil in the transport channel.

The disadvantage of said method is necessity for additional technical accessories, continuous supply of extraneous process liquid in considerable amounts, increase of the total amount of liquid media supplied through the channel, decrease of oil supplied to consumer and general decrease of technological effectiveness of the process.

One of the purposes of the invention is to decrease the supplied liquid medium viscosity, decrease the deposits on the transport channel walls, increase the channel throughput capacity, reduce the material cost and power consumption for liquid medium pumping and generally improve technological effectiveness of the process.

The said purpose can be achieved so that in the known method of a liquid medium, mainly of liquid hydrocarbon mixture, supply from a source to a consumer by the liquid medium in the source physical-chemical parameters determination, a transport channel arrangement and needed pressure differential along the said channel provision the liquid medium downstream its pressure along the transport channel values are set, downstream the pressure first and second set values are selected, on the first one of which in the channel added resistance is made, the liquid medium pressure is transformed into rotation-screw movement with a certain relationship of rotation and forward speeds and a cavity is formed, and the pressure second set value is forced-downgraded to the needed level and the said level is continuously maintained with formation of cavitation controlled zone after the added resistance.

Besides it is possible to monitor the liquid medium viscosity value after the cavitation zone and to control the cavitation zone in accordance with the said viscosity value, and in case of liquid hydrocarbon mixture it is possible to additionally determine the said mixture in the source nanostructure, in accordance with which the mixture rotation and forward speeds relationship is selected.

The described method for supplying of a liquid medium from a source to a consumer supply can be used with any liquid, for example with water, liquid hydrocarbon mixture (oil and oil products), emulsions etc. for both transportation through an aboveground piping system and borehole mining.

A specific device can be used in accordance with said method in each specific case depending on the physical-chemical parameters of the supplied liquid and on the liquid source type.

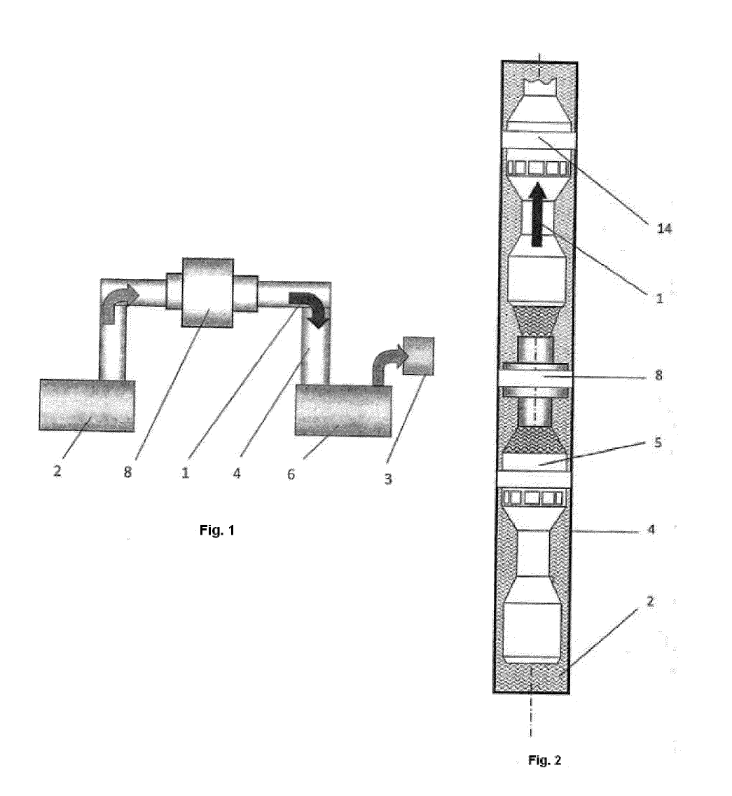

The FIG. 1 schematically represents the device using the put forward method of a liquid medium to a consumer supply through an aboveground piping system.

The FIG. 2 schematically represents the device using the put forward method of a liquid medium to a consumer supply in case of a borehole mining.

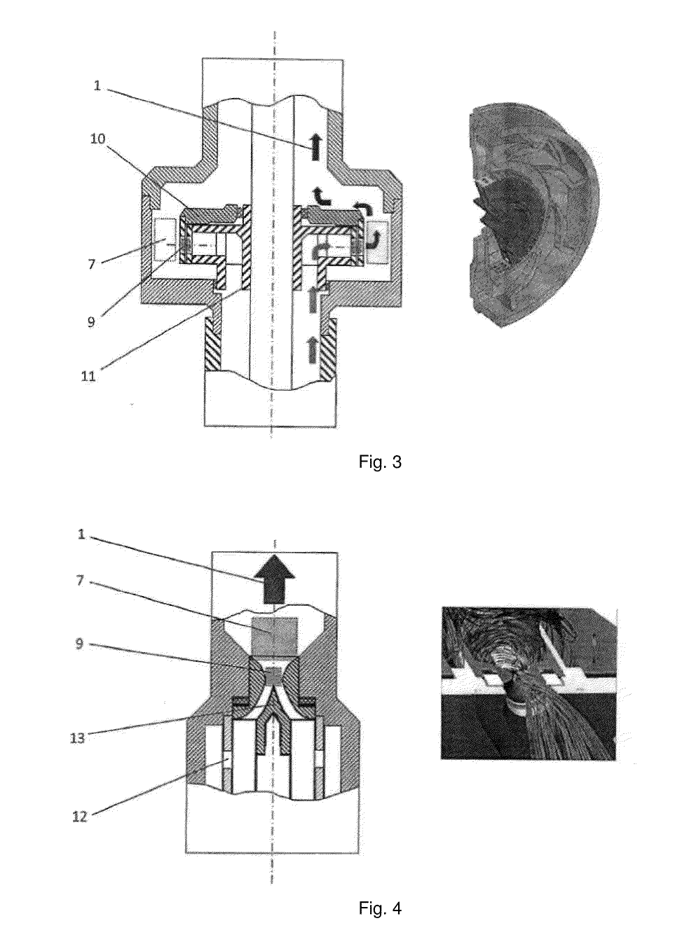

The FIG. 3 represents the variant of a flow transformation system in form of a pulse apparatus of a rotor type.

The FIG. 4 represents an embodiment of a flow transformation system in form of a dynamic nozzle.

When a liquid medium 1 is supplied from a source 2 to a consumer 3 a transport channel 4 is arranged. If the source 2 has the necessary pressure value for the medium supply, for example by well lift, its own pressure is used as propelling power. In case of pressure loss in the source 2 or the pressure value is insufficient for the medium 1 to the consumer 3 supply, the needed pressure value in the source 2 is provided by means of any known method, for example by installation of a pump 5. In the general case the liquid medium 1 physical-chemical parameters are determined and by calculation or experience the medium pressure values are determined along the transport channel 4 in case of the medium possible source 2 pressure pumping. The first and second preset pressure point in the channel 4 location is determined and at the place of the channel with the first pressure set point a local resistance is located in the channel and at the place with the second pressure set point a depressing device 6 is installed, which allows to force-downgrade the pressure second set point to the needed level with formation of cavitation controlled zone 7. As a local resistance a flow transformation system 8 is selected, which provides the medium 1 rotation-screw movement with a certain relationship of rotation and forward speeds and simultaneously forms a caviation 9.

It is necessary to note, that in case of the put forward method use there is a strict volume-location dependence of the cavitation controlled zone 7 as regard to the source 2, magnitudes of the pressure first and second set points and the level value, to which the second pressure is downgraded with the liquid medium physical-chemical parameters, its consumption, the transport channel 4 length and the used equipment.

In each specific case for each specific liquid medium in accordance with its physical-chemical parameters the pressure first and second set points are preliminarily calculated and set depending on the conditions of the cavitation zone 7 formation with the needed volume at the needed place as regard to the source 2 and with account of possibility to provide necessary operating conditions with the used equipment. The value of the first set pressure and its location are determined according to the necessity to provide optimal operating pressure at the used flow transformation system 8 inlet. And while selecting one or another system 8 the optimal operating pressure at is inlet varies correspondingly and from here the value and location of the first set pressure. The second set pressure value is determined, in its turn, by both selected depressing device 6 performance specifications and the necessity to provide optima operation of the flow transformation selected system 8.

On the other hand the pressure first and second set points taken together are to provide the cavitation 7 controlled zone with the needed values of volume.

In each specific case any known device can be used as a flow transformation system 8, for example a rotor type pulse apparatus with a stator 10 and a rotor 11, a dynamic nozzle with elements 12 and 13 forming vortex field and cavity correspondingly or any other known technical decision.

As a depressing device an open chamber for example can be used or a pump 14, herewith the pump 14 performance specifications are to be agreed with the source pressure, liquid medium consumption and the pressure needed level, to which the second set pressure value is to be downgraded, or any other known technical decision.

The pressure level, to which the second set pressure value is downgraded, is determined by selection of a flow transformation specific system 8, its performance specifications and is to provide its optimal operation.

Selection of one or another equipment for implementation of the method being described with one or another technical accessory effects the level of the liquid medium viscosity reduction, and the equipment selection optimality is specified by the supplied medium physical-chemical parameters and the needed degree of its viscosity reduction.

The liquid medium supply put forward method is described for use of the most effective equipment, which provides the liquid medium viscosity reduction the most effective and guaranteed way. As a flow transformation system 8 a dynamic nozzle is selected and as a depressing device a pump 14 is selected.

Preliminarily, prior to a liquid medium 1 supply, its physical-chemical parameters are determined as well as the needed value of pressure in the source 2 to provide the medium 1 set consumption through an arranged transport channel 4 and pressure values along the channel 4 are determined by calculation or by experience.

In accordance with the liquid medium 1 properties and its needed consumption a dynamic nozzle with corresponding performance specifications and the depressing pump 14 are selected. For the purpose of the dynamic nozzle optimal operation the inlet and outlet pressure values are determined. And with account of the pump 14 operating characteristics the pressure first and second values are set as well as the pressure level, to which the second set pressure value is downgraded. The pressure first and second set points locations in the transport channel 4 are determined and the dynamic nozzle and the pump 14 are located at the determined places. Upon preliminary work completion the liquid medium 1 supply begins.

The liquid medium 1 us supplied to the nozzle inlet and while passing through the nozzle the flow is swirled at the element 12 obtaining a spring form with the set value of rotationship and forward speeds relation, and the element 13 provides continuous nucleation of bubbles, which line up downstream the medium flow being treated with formation of the cavity 9, which later passes into the cavitation 7 controlled zone.

In the course of treatment the liquid medium while passing through the cavitation 7 zone is exposed to wave slamming, generated with cavitation bubbles collapse. Besides partial “micro-cracking” takes place—bond opening with radical and decreased molecular weight hydrocarbon generation. Flow rotation provides the entire flow cavitation treatment efficiency.

By selecting the elements 12 and 13 design features as well as by setting the treated flow corresponding radial and forward speeds it is possible to provide certain volume of the cavitation 7 controlled zone, its intensity and accordingly the degree of cavitation effect on the liquid medium state. As a result of the liquid medium in the vorticity and cavitation fields integrated treatment its viscosity is reduced and deposits on the channel 4 walls decrease.

In the course of the medium treatment it is possible to monitor its viscosity values and if necessary to control the cavitation controlled zone size by the liquid medium flow to the flow transformation system 8 parameters control or by the second set pressure depressing level control with the pump 14.

While supplying liquid hydrocarbons (oil and oil products) in addition to the physical-chemical parameters it is possible to determine also the mixture nanostructure (micellae, conglomerates etc.), in accordance with which the dynamic nozzle elements 12 and 13 one or another structure is selected, providing optimal relationship of rotation and forward speeds for certain nanostructure mixture treatment.

Thus the put forward technical decision reduces the supplied liquid medium viscosity, decreases deposits thereof to the transport channel walls, improves the channel itself throughput capacity, provides material cost and power consumption saving and improves the process efficiency in general.

Information sources:
1. Russian patent No. 2 003 784 M [symbol] E21B 43/00 published in 1992.
2. Russian patent No. 2 088 749 M [symbol] E21B 43/00 published in 1997.

1. The method for supplying a liquid medium, mainly liquid hydrocarbons, from a source to a consumer by determining physical-chemical parameters of the liquid medium at the source, arranging a transport channel and providing needed pressure differential along the said channel characterized in that along the transport channel the value of the pressure of the liquid medium is set, a first liquid pressure value and a second liquid pressure value are selected along the direction of liquid transport, at the first pressure value additional resistance in the channel is provided, the liquid medium movement is transformed into rotation-screw with a predetermined relationship of rotational and forward speeds and a cavitation is formed, wherein and the second liquid pressure value is reduced to a needed level and the level is continuously maintained with cavitation controlled zone after the added resistance provision.

2. The method of a liquid medium supply according to claim 1 characterized in that the liquid medium viscosity is monitored after the cavitation controlled zone and the cavitation zone is controlled in accordance with the liquid medium viscosity.

3. The method of a liquid medium supply according to claim 1 characterized in that while using liquid hydrocarbon mixture the mixture in the source nanostructure is additionally determined, in accordance with which the relationship of the mixture rotation and forward speeds is selected.
